(19) United States
(12) Patent Application Publication
(10) Pub. No.: US 2024/0255287 A1
(43) Pub. Date: Aug. 1, 2024

(54) Method and Device for Determining a Travel Trajectory for Repeated Performance of a Parking Maneuver

(71) Applicant: Bayerische Motoren Werke Aktiengesellschaft, Muenchen (DE)

(72) Inventors: Mohamad Mounir EL DANA, Muenchen (DE); Benedikt HOFFMANN, Muenchen (DE); Benjamin KRIMMER, Muenchen (DE); Rebecca PASCAL, Muenchen (DE); Daniel TELSCHOW, Muenchen (DE)

(21) Appl. No.: 18/426,716

(22) Filed: Jan. 30, 2024

(30) Foreign Application Priority Data
Jan. 31, 2023 (DE) 10 2023 102 234.2

(51) Int. Cl. G01C 21/28

(52) U.S. Cl. CPC G01C 21/28

(57) ABSTRACT

An apparatus includes a device. The device is configured to determine a travel trajectory associated with repeated performance of a parking maneuver of a vehicle. The device is also configured to detect that a travel trajectory recorded associated with the parking maneuver includes an end position within a parking space which deviates from a target position. The device is also configured to determine a travel trajectory adapted with regard to the recorded travel trajectory associated with the parking maneuver so that the adapted travel trajectory includes an adapted target position which does not deviate from the target position. The device is also configured to use the adapted travel trajectory for repeated performance of the parking maneuver.

### BACKGROUND AND SUMMARY

This application claims priority under 35 U.S.C. § 119 from German Patent Application No. 10 2023 102 234.2, filed Jan. 31, 2023, the entire disclosure of which is herein expressly incorporated by reference.

The disclosure relates to a method and a corresponding device which are configured to assist the user of a vehicle in determining a travel trajectory for the repeated performance of parking maneuvers.

A vehicle may include a driver assistance system that enables the user of the vehicle to record and store a travel trajectory driven in a manual driving mode. The travel trajectory may relate to a parking maneuver of the vehicle in a parking space (in particular a perpendicular parking space). The stored travel trajectory may be used at a later point in time to automatically guide the vehicle along the stored travel trajectory. In this way, the comfort of the vehicle may be increased when repeating the performance of parking maneuvers.

The present document relates to the problem of further increasing the comfort of a vehicle user when determining a travel trajectory for a parking maneuver.

The problem is solved by each of the independent claims. Advantageous embodiments are described, inter alia, in the dependent claims. It should be noted that additional features of a claim dependent on an independent patent claim without the features of the independent patent claim or only in combination with a subset of the features of the independent patent claim may form a separate disclosure independent of the combination of all features of the independent patent claim, which may be made the subject of an independent claim, a divisional application or a subsequent application. This applies in the same way to technical teachings described in the description, which may form an disclosure independent of the features of the independent claims.

According to one aspect, a device for determining a travel trajectory for repeated performance of a parking maneuver of a (motor) vehicle is described. The device may be part of a driver assistance system for repeated performance of parking maneuvers.

The device may be configured to record, in a recording mode (of the driver assistance system), a trajectory driven by the vehicle when the parking maneuver is performed (i.e. while driving) in order to determine a recorded trajectory. In the recording mode, the longitudinal and/or lateral control of the vehicle during the driving maneuver may be performed manually by the driver of the vehicle.

As part of recording the travel trajectory, trajectory data may be acquired and recorded. The trajectory data may specify for each of a plurality of points and/or positions along the travel trajectory (starting from a start position to an end position of the trajectory)
the coordinates of the respective position;
the orientation and/or heading of the vehicle at the respective position; and/or
the speed of the vehicle at the respective position.

The trajectory data of the travel trajectory may be stored in a memory unit of the vehicle. Furthermore, the trajectory data may be used in a replay mode to control the vehicle automatically (with automated longitudinal and/or lateral control) along the travel trajectory (from the initial position to the end position of the travel trajectory).

The device is configured to detect that the travel trajectory recorded for the parking maneuver includes an end position in a parking space (for the vehicle) that deviates from a target position. The parking space may be locally delimited and/or delimited by one or more markings, in particular road surface markings. The one or more markings may in particular have the shape of lines. The target position may correspond to a specific, in particular central, parallel and/or perpendicular position (i.e. a specific parallel and/or perpendicular position or arrangement) of the vehicle between two markings with regard to the local delimitation of the parking space.

The device may be configured to detect, based on environmental data from one or more environmental sensors (in particular cameras) of the vehicle, that the travel trajectory recorded for the parking maneuver has an end position within the parking space that deviates from the target position. This may be detected during or at the end of the journey used to record the recorded trajectory (based on environmental data recorded during or at the end of the journey). For example, it may be detected that the end position is arranged off-center between the boundary lines of the parking space.

The device is further configured to determine a travel trajectory for the parking maneuver that is adapted with regard to the recorded travel trajectory so that the adapted travel trajectory has an adapted target position which does not deviate from the target position and/or which corresponds to the target position. The adapted trajectory may be determined on the basis of environmental data from one or more environmental sensors of the vehicle, the environmental data relating to the one or more markings, in particular road markings, for the local delimitation of the parking space. The environmental data may be recorded during repeated performance of the parking maneuver.

The device is further configured to use the adapted travel trajectory for repeated performance of the parking maneuver. For example, the repeated performance of the parking maneuver may be started based on the recorded trajectory. During the repeated performance of the parking maneuver, environmental data relating to the one or more markings for the local delimitation of the parking space may be recorded based on one or more environmental sensors of the vehicle. Furthermore, the recorded trajectory may be adapted during the repeated performance of the parking maneuver based on the environmental data in order to determine the adapted trajectory in a particularly reliable and robust manner.

A device is therefore described which enables adapting a (potentially incorrectly or imprecisely) recorded trajectory in order to increase the convenience of repeated performance of a parking maneuver.

The device may be configured to determine, in particular in response to a user input, that the recorded trajectory is to be stored in the memory unit of the vehicle following the trip used to record the recorded trajectory (in order to be able to use the recorded trajectory for repeated performance of the parking maneuver).

The recorded trajectory may then be caused to be stored in the memory unit together with a note indicating that the end position of the recorded trajectory deviates from the target position. In this way, the recorded trajectory may be adapted in a particularly robust manner to increase comfort during repeated performance.

Following the repeated performance of the parking maneuver, the device may be configured to store the adapted trajectory (as part of the repeated performance of the parking maneuver), in particular instead of the recorded trajectory, in the memory unit of the vehicle, in particular in such a way that subsequent performance of the parking maneuver is started directly with the adapted trajectory. In this way, the robustness and comfort of the driver assistance system may be further increased.

The device may be configured to determine the adapted trajectory in such a way that the start positions of the adapted trajectory and the recorded trajectory are the same.

Alternatively or additionally, the adapted trajectory may be determined in such a way that the adapted trajectory reduces, in particular minimizes, a cost function. The cost function may be configured to reduce, in particular, minimize the deviation of the adapted trajectory from the recorded trajectory. The target position for the end position may be considered as a secondary condition. In this way, a particularly convenient adapted trajectory may be determined.

The device may be configured to determine whether or not the end position of the recorded trajectory should be adapted. This may be determined, for example, based on a user input or based on a preference setting of the driver assistance system. The user input may be provided in response to a request that was issued directly following the trip, during which the travel trajectory was recorded, or which was issued immediately before the repeated performance of the parking maneuver.

The adapted travel trajectory for the parking maneuver may be determined and used for repeated performance of the parking maneuver if, in particular only if, it is determined that the end position of the recorded trajectory is to be adapted. On the other hand, the recorded travel trajectory may be used for repeated (automatic) performance of the parking maneuver in order to place the vehicle on the parking space at the end position of the recorded travel trajectory if it is determined that the end position of the recorded trajectory should not be adapted. The convenience of the driver assistance system may be further increased by selectively using the recorded trajectory or the adapted trajectory.

According to another aspect, a (road) motor vehicle (in particular a passenger car or a truck or a bus or a motorcycle) is described, which comprises one or more of the devices described in this document.

According to a further aspect, a method for determining a travel trajectory for repeated performance of a parking maneuver of a (motor) vehicle is described. The method comprises detecting that a travel trajectory recorded for the parking maneuver has an end position in a parking space (for the vehicle) that deviates from a predefined target position. The method also comprises determining a travel trajectory for the parking maneuver which is adapted with regard to the recorded travel trajectory in such a way that the adapted travel trajectory includes an adapted target position that does not deviate from the target position. The adapted travel trajectory may then be used repeated performance of the parking maneuver.

According to a further aspect, a software (SW) program is described. The SW program may configured to be executed on a processor (for example on a vehicle control device) and thus to perform one or more of the methods described in this document.

According to a further aspect, a storage medium is described. The storage medium may include an SW program which is configured to be executed on a processor and thus to perform one or more of the methods described in this document.

It should be noted that the methods, devices and systems described in this document may be used alone or in combination with other methods, devices and systems described in this document. Furthermore, any aspect of the methods, devices and systems described in this document may be combined in a variety of ways. In particular, the features of the claims may be combined with one another in a variety of ways. Furthermore, features listed in parentheses are to be understood as optional features.

The disclosure is described in more detail below on the basis of exemplary embodiments. Other objects, advantages and novel features of the present disclosure will become apparent from the following detailed description of one or more preferred embodiments when considered in conjunction with the accompanying drawings, in which:

### BRIEF DESCRIPTION OF THE DRAWINGS

FIG. 1 shows exemplary components of a vehicle;

FIG. 2 shows an exemplary recorded travel trajectory and an exemplary adapted travel trajectory for a parking maneuver;

FIG. 3 shows an exemplary output of the vehicle user interface for adapting a recorded travel trajectory; and

FIG. 4 shows a flow chart of an exemplary method for adapting a travel trajectory for a parking maneuver.

### DETAILED DESCRIPTION OF THE DRAWINGS

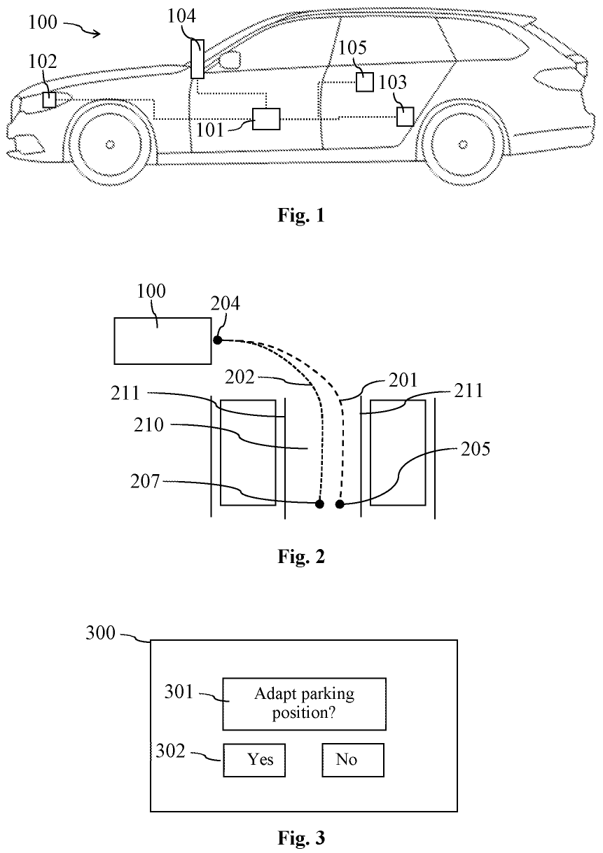

As explained above, the present document relates to increasing the comfort of a user of a vehicle when determining a travel trajectory for the repeated performance of a parking maneuver. In this context, FIG. 1 shows an exemplary vehicle 100 with one or more environmental sensors 102 (e.g. at least one camera, at least one radar sensor, at least one lidar sensor, at least one ultrasonic sensor, etc.), which are each configured to detect environmental data (i.e. sensor data) relating to the environment of the vehicle 100. A control device 101 of the vehicle 100 may be configured to evaluate the environmental data in order to detect one or more objects in the vicinity of the vehicle 100.

The device 101 may also be designed to operate one or more longitudinal and/or lateral control actuators 103 of the vehicle 100 (for example a drive motor, a brake device and/or a steering device) in order to automatically control the vehicle 100 longitudinally and/or laterally. The one or more actuators 103 may be operated as a function of the environmental data, in particular as a function of the one or more detected objects.

The vehicle 100 may further include a user interface 104, which enables interaction between the user and the vehicle 100, for example to activate or deactivate a driver assistance function and/or to inform the user about the status of a driver assistance function. The user interface 104 may include one or more operating elements and/or one or more output elements (e.g. a screen).

The vehicle 100 may include a driver assistance system which is configured to record a travel trajectory driven by the vehicle 100. The travel trajectory may be driven manually by the driver of the vehicle 100 and/or automatically by the vehicle 100. Trajectory data relating to the travel trajectory may be stored in a memory unit 105 of the vehicle 100. The trajectory data may display for each of a plurality of positions along the travel trajectory,
coordinates of the respective position (for example relative to a world coordinate system and/or relative to a coordinate system of the vehicle 100);
the orientation and/or orientation of the vehicle 100 at the respective position; and/or
the travel speed of vehicle 100 at the respective position.

The recording of a travel trajectory may be started and/or stopped explicitly by the user of the vehicle 100 (via the user interface 104). In this way, the start position and/or the end position of the stored travel trajectory may be determined precisely.

FIG. 2 shows an exemplary driving situation in which the vehicle 100 is driven along a travel trajectory 201 to a parking space 210, the parking space 210 being arranged between two marking lines 211 (generally markings). In this case, the driver of the vehicle 100 may start recording the travel trajectory 201 at the start position 204 (for example by activating an operating element of the user interface 104). The driver may manually drive the vehicle 100 laterally and/or longitudinally to an end position 205 in the parking space 210. The path traveled by the vehicle 100 between the start position 204 and the end position 205 may be recorded as a travel trajectory 201 and, if necessary, stored in the memory unit 105 of the vehicle 100.

A specific (local) target location may be provided for the end position 205 in a parking space 210. The target position may, for example, specify a specific perpendicular position of the end position 205 on the parking space 210. In particular, the target position may specify that the end position 205 should be arranged centrally on the parking space 210 between the two marking lines 211 of the parking space 210. Alternatively or additionally, the target position may specify a specific parallel position of the end position 205 on the parking space 210. For example, a specific longitudinal distance to a front-side and/or rear-side boundary of parking space 210 may be provided.

The device 101 may be configured to detect that the travel trajectory 201 recorded by the user of the vehicle 100 includes an end position 205, which deviates from the target position for the end position in a parking space 210. In the example shown in FIG. 2, it may be seen, for example, that the end position 205 is not centrally arranged in the perpendicular direction (perpendicular to the direction of travel of the vehicle 100), but is arranged relatively close to one of the two marking lines 211.

The recorded trajectory 201 may then be caused to be adapted in order to determine an adapted trajectory 202, the adapted trajectory 202 having an adapted end position 207, which corresponds to the target position, which, for example, is arranged centrally on the parking space 210 in the perpendicular direction.

The adapted travel trajectory 202 may be determined using a cost function based on the recorded travel trajectory 201, for example in such a way that the value of the cost function is reduced, in particular minimized. The cost function may depend on the deviation, for example the mean quadratic and/or mean absolute deviation, of the adapted travel trajectory 202 from the recorded travel trajectory 201. In addition, when determining the adapted travel trajectory 202, the one or more secondary conditions relating to the target position for the adapted end position 207 may be taken into account. In particular, it may be considered as a secondary condition that the adapted end position 207 of the adapted travel trajectory 202 corresponds to the target position. Furthermore, it may be considered as a secondary condition that the recorded travel trajectory 201 and the adapted travel trajectory 202 have the same start position 204.

The device 101 may be configured to store the adapted trajectory 202 (optionally instead of the recorded trajectory 201) in the storage unit 105. The repeated performance of the parking maneuver (as part of the replay mode of the driver assistance system for the repeated performance of parking maneuvers) may then be performed based on the adapted trajectory 202. In this way, the comfort of the driver assistance system may be increased.

The device 101 may be configured, as part of an interaction with the user (via the user interface 104 of the vehicle 100), to clarify whether or not the recorded trajectory 201 should be adapted. For example, as shown in FIG. 3, an inquiry 301 may be issued as to whether or not the end position 205 of the recorded travel trajectory 201 should be adapted. Depending on a user input 302 with regard to the request 301, the recorded trajectory 201 may or may not be adapted. Furthermore, depending on the user input 302, the recorded trajectory 201 or the adapted trajectory 202 for the parking maneuver may be stored in the memory unit 105 of the vehicle 100.

As already explained above, it may occur that the driver manually parks the vehicle 100 between two lines 211 (for example in a perpendicular parking space and/or in a parallel parking space) and records the travel trajectory 201 traveled in the process. The end position 205 of the recorded trajectory 201 may differ from a central target position. If the recorded trajectory 201 is used for repeated performance of the parking maneuver, this causes the end position 205 of the vehicle 100 to deviate from the central target position even during repeated performance (in accordance with the recorded trajectory 201).

Localization difficulties (for example due to impairment of the position data determined by the GNSS (global navigation satellite system) receiver of the vehicle 100) may cause the end positions 205 of the vehicle 100 to vary slightly during repeated performance. If the originally recorded end position 205 of the vehicle 100 deviates from the target position in the recorded trajectory 201, in extreme cases, such localization difficulties may result in the vehicle 100 being parked on a marking line 211 of the parking space 210 (and thus immediately adjacent to an adjacent parking space) during repeated performance of the parking maneuver, which is typically undesired.

The measures described in this document enable the user of the vehicle 100 to decide on the end position 205, 207 during a parking maneuver on a detected line parking space 210. For example, the user may be asked via the user interface 104 whether the vehicle 100 should (in future) be parked centrally between lines 211. If this is the case, an adapted trajectory 202 may be determined, which causes the vehicle 100 to be parked centrally between the lines 211, even if the vehicle 100 was not parked centrally between the lines 211 in the recorded trajectory 201 (but was potentially parked askew and/or with an offset). The lines 211 may be captured by the camera 102 of the vehicle 100 during replay (i.e. during repeated performance of the parking maneuver) and may be used as additional features to cause the adapted end position 207 to be arranged centrally between the lines 211. Path planning may then be performed (taking into account the environmental data from the camera 102) to determine the adapted trajectory 202, which includes an adapted end position 207, which is arranged centrally between the lines 211.

In one example, the user may have recorded a trajectory 201. Following recording, a request 301 may be issued via the user interface 104 as to whether the end position 205, 207 of the recorded trajectory 201 should in future correspond to the target position or whether the end position 205 of the recorded trajectory 201 should be maintained. Alternatively or additionally, request 301 may be issued immediately before repeated performance of the parking maneuver. In another example, an automatic decision may be made as to whether or not the end position 205 should be adapted (for example on the basis of a preference setting of the driver assistance system).

If the recorded trajectory 201 is to be adapted during repeated performance of the parking maneuver based on the environmental data, the lines 211 of the parking space 210 may be detected and taken into account when adapting the trajectory 201 in order to cause the end position 207 of the adapted trajectory 202 to correspond to the target position (for example in the center between the two lines 211). The adapted trajectory 202 determined as part of the repeated performance of the parking maneuver may be stored in the memory unit 105 (optionally instead of the recorded trajectory 201).

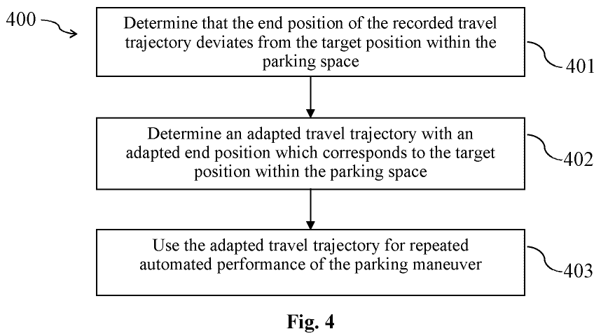

FIG. 4 shows a flow chart of a (potentially computer-implemented) method 400 for determining a travel trajectory for repeated performance of the parking maneuver of a (motor) vehicle 100. The method 400 comprises detecting 401 that a travel trajectory 201 recorded (as part of a recording mode of the driver assistance system) for the parking maneuver includes an end position 205 in a parking space 210, which differs from a (predefined, potentially central) target position. This may be detected during and/or at the end of the (manual) journey to record the trajectory 201 based on the environmental data from the one or more environmental sensors 102 of the vehicle 100 (which was acquired during or at the end of the journey to record the trajectory 201).

The method 400 also comprises determining 402 a travel trajectory 202 adapted to the recorded travel trajectory 201 for the parking maneuver so that the adapted travel trajectory 202 includes an adapted target position 207 that does not deviate from the target position (or which corresponds to the target position). The adapted trajectory 202 may be determined, for example, on the basis of environmental data from the one or more environmental sensors 102, which are recorded during repeated performance of the parking maneuver.

The method 400 also comprises using 403 the adapted travel trajectory 202 for repeated performance of the parking maneuver. Furthermore, the adapted travel trajectory 202 may be stored in the memory unit 105 of the vehicle 100 so that subsequent performance of the parking maneuver may be started directly with the adapted travel trajectory 202.

The aspects described in this document may increase the comfort of a user during repeated performance of a parking maneuver in an efficient and reliable manner.

The present disclosure is not limited to the exemplary embodiments shown. In particular, it should be noted that the description and the figures are only intended to illustrate the principle of the proposed methods, devices and systems by way of example.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

What is claimed is:

1. An apparatus comprising:
a device configured to:
determine a travel trajectory associated with repeated performance of a parking maneuver of a vehicle,
detect that a travel trajectory recorded associated with the parking maneuver includes an end position within a parking space which deviates from a target position;
determine a travel trajectory adapted with regard to the recorded travel trajectory associated with the parking maneuver so that the adapted travel trajectory includes an adapted target position which does not deviate from the target position; and
use the adapted travel trajectory for repeated performance of the parking maneuver.

2. The apparatus according to claim 1, wherein
the device is further configured to determine the adapted travel trajectory based on environmental data from one or more environmental sensors of the vehicle; and
the environmental data relate to one or more road surface markings, locally delimiting the parking space.

3. The apparatus according to claim 1, wherein the device is further configured to:
start the repeated performance of the parking maneuver on the basis of the recorded travel trajectory;
during the repeated performance of the parking maneuver, using one or more environmental sensors of the vehicle to record environmental data relating to one or more markings locally delimiting the parking space; and
adapt the recorded travel trajectory based on the environmental data during repeated performance of the parking maneuver in order to determine the adapted travel trajectory.

4. The apparatus according to claim 3, wherein the device is further configured to, following repeated performance of the parking maneuver, cause the adapted travel trajectory, instead of the recorded travel trajectory, to be stored in a memory unit of the vehicle, so that a subsequent performance of the parking maneuver is started directly with the adapted travel trajectory.

5. The apparatus according to claim 1, wherein the device is also configured to:
determine whether or not the end position of the recorded travel trajectory is adapted; and
determine the adapted travel trajectory for the parking maneuver and use it for repeated performance of the parking maneuver if, and only if, it is determined that the end position of the recorded travel trajectory is adapted; and/or
use the recorded travel trajectory for repeated performance of the parking maneuver in order to park the vehicle in the parking space at the end position of the recorded travel trajectory when it is determined that the end position of the recorded travel trajectory is not adapted.

6. The apparatus according to claim 5, wherein the device is further configured to:
determine based on a user input on a user interface of the vehicle whether or not the end position of the recorded travel trajectory should be adapted, the user input being made in response to a request which was issued directly following a trip in which the recorded travel trajectory was recorded, or which was issued immediately before the repeated performance of the parking maneuver; and/or
determine, based on a preference setting of a driver assistance system for repeated performance of parking maneuvers, whether or not the end position of the recorded travel trajectory should be adapted.

7. The apparatus according to claim 1, wherein
the recorded travel trajectory extends from a start position to the end position; and
the device is further configured to determine the adapted travel trajectory so that the start positions of the adapted travel trajectory and the recorded travel trajectory coincide.

8. The apparatus according to claim 1, wherein the target position corresponds to a central, parallel and/or perpendicular position of the vehicle between two markings locally delimiting the parking space.

9. The apparatus according to claim 1, wherein the device is further configured to:
detect, based on environmental data from one or more environmental sensors of the vehicle, that the recorded travel trajectory recorded for the parking maneuver includes an end position within the parking space which deviates from the target position; and/or
at the end of a trip used to record the recorded travel trajectory, detect that the recorded travel trajectory recorded for the parking maneuver includes an end position within the parking space which deviates from the target position.

10. The apparatus according to claim 1, wherein the device is further configured to:
determine, in response to a user input, that the recorded travel trajectory is stored in a memory unit of the vehicle following a trip to record the recorded trajectory; and
in response thereto, to cause the recorded travel trajectory to be stored in the storage unit together with a note indicating that the end position of the recorded travel trajectory differs from the target position.

11. A method for determining a travel trajectory for repeated performance of a parking maneuver of a vehicle, the method comprising:
detecting that a travel trajectory recorded for the parking maneuver includes an end position within a parking space which deviates from a target position;
determining a travel trajectory adapted with regard to the recorded travel trajectory for the parking maneuver so that the adapted travel trajectory includes an adapted target position which does not deviate from the target position; and
using the adapted travel trajectory for repeated performance of the parking maneuver.
